(19) United States
(12) Patent Application Publication
(10) Pub. No.: US 2013/0214544 A1
(43) Pub. Date: Aug. 22, 2013

(54) One hand operable cabinet latch

(71) Applicants: Kung-Cheng Chen, Taichung (TW); Lung-Chuan Huang, Taichung (TW)

(72) Inventors: Kung-Cheng Chen, Taichung (TW); Lung-Chuan Huang, Taichung (TW)

(21) Appl. No.: 13/400,127

(22) Filed: Feb. 20, 2012

(51) Int. Cl. E05C 1/10

(52) U.S. Cl. 292/162

(57) ABSTRACT

A one hand operable cabinet latch is provided with upper and lower sub-assemblies including a hollow cylinder, a spring-biased rotatable bolt projecting out of the cylinder, and a knob secured to one end of the bolt and projecting out of an opening of the cylinder; upper and lower mounting plates secured to one door panel; upper and lower driven members each including a groove at one end with the knob slidably projecting out of the groove, a slot at the other end, and a trigger at the other end of the driven member; an intermediate interconnecting member secured to the one door panel and including two fastening members each driven through the slot into the interconnecting member to slidably secure each of the driven members to the interconnecting member; and upper and lower catches mounted on an inner surface of a top and a bottom of the cabinet respectively.

### BACKGROUND OF THE INVENTION

1. Field of the Invention

The invention relates to cabinet latches and more particularly to a one hand operable cabinet latch.

2. Description of Related Art

A conventional cabinet latch assembly is mounted on an upper portion of an inner surface of cabinet door and a lower portion thereof respectively. The bolt of each cabinet latch assembly is fitted into a notch on a top edge or bottom edge of the front end of cabinet frame in a locked position. For opening the cabinet, a person has to use one hand to clear one bolt out of one upper notch and the other hand to clear the other bolt out of the lower notch respectively.

However, both hands are required to open the cabinet or close same. This is inconvenient. Thus, the need for a cabinet latch which can be opened or closed by one hand exists.

### SUMMARY OF THE INVENTION

It is therefore one object of the invention to provide a latch for releasably locking of one of two hinged door panels of a cabinet comprising upper and lower sub-assemblies disposed on upper and lower portions of one side of an inner surface of one door panel respectively, each of the upper and lower sub-assemblies comprising a hollow cylinder having an elongated opening, a biasing member anchored on a bottom of the cylinder, a rotatable, sliding bolt having one end secured to one end of the biasing member distal the bottom of the cylinder and the other end projecting out of the cylinder, and a knob secured to one end of the bolt and projecting out of the elongated opening wherein the upper and lower sub-assemblies are oriented in opposite directions; upper and lower mounting plates secured to the one door panel wherein the upper mounting plate is secured to the upper sub-assembly and the lower mounting plate is secured to the lower sub-assembly respectively; upper and lower driven members each comprising a groove at one end with the knob slidably projecting out of the groove, a slot at the other end, and a trigger at the other end of the driven member wherein the upper and lower driven members are oriented in opposite directions; an intermediate interconnecting member secured to the one door panel and comprising two fastening members each driven through the slot into the interconnecting member to slidably secure each of the driven members to the interconnecting member; and upper and lower catches mounted on an intermediate portion of an inner surface of a top of the cabinet and an intermediate portion of a bottom of the cabinet respectively, the upper and lower catches lock the bolts of the upper and lower sub-assemblies respectively in a closed position of the one door panel.

The above and other objects, features and advantages of the invention will become apparent from the following detailed description taken with the accompanying drawings.

### BRIEF DESCRIPTION OF THE DRAWINGS

FIG. 1 is a perspective view of a portion of a cabinet incorporating a latch assembly according to a first preferred embodiment of the invention, the cabinet doors being open;

FIG. 2 is an exploded view of the latch assembly disengaged from the left panel;

FIG. 3 is a front view of the latch assembly shown in FIG. 1;

FIG. 4 is a longitudinal sectional view of the closed cabinet of FIG. 1 showing a closing operation of the latch assembly;

FIG. 5 is a view similar to FIG. 4 showing an opening operation of the latch assembly; and

FIG. 6 is a perspective view of a latch assembly according to a second preferred embodiment of the invention, the latch assembly being mounted on an inner surface of one side of cabinet door panel.

### DETAILED DESCRIPTION OF THE INVENTION

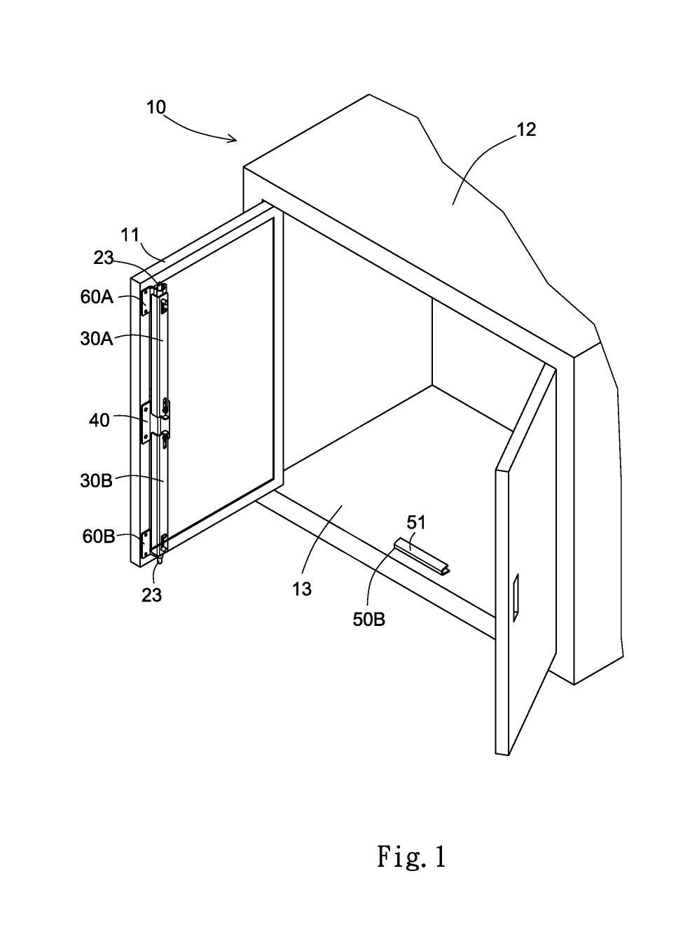

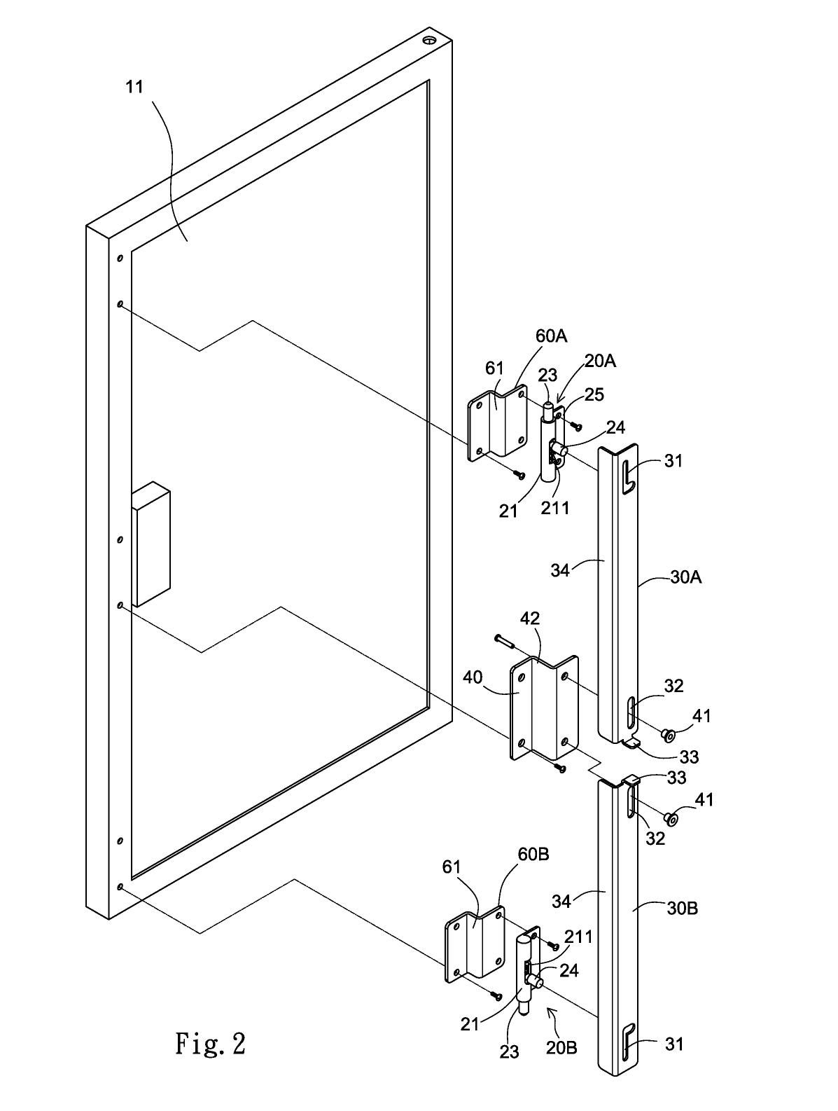

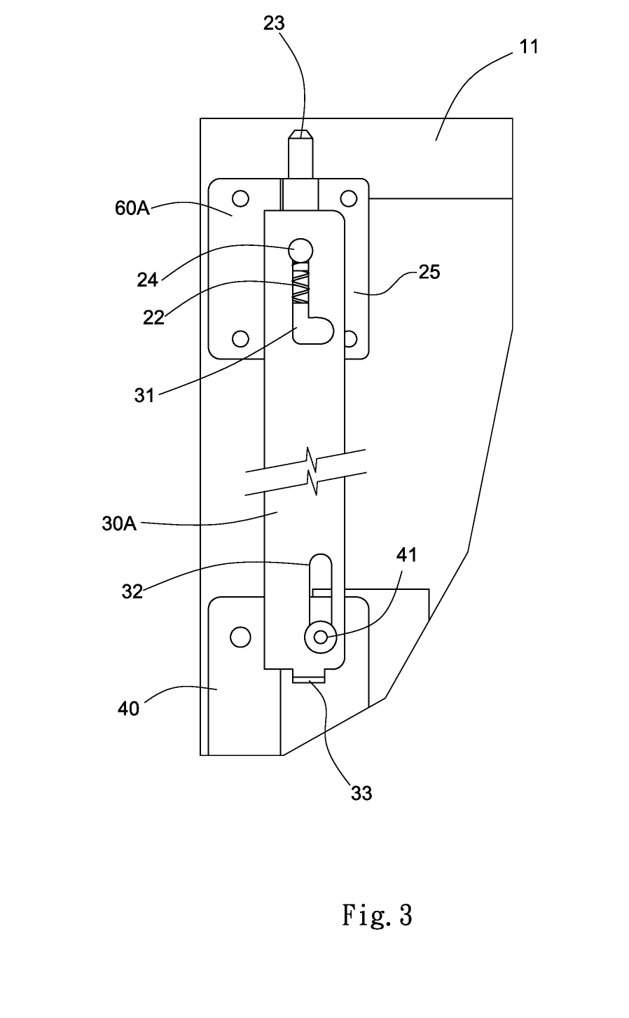

Referring to FIGS. 1 to 5, a latch assembly accordance with a first preferred embodiment of the invention is shown. The latch assembly is mounted on an inner surface of one side of one door panel 11 of a cabinet 10. A lock is mounted on the other door panel of the cabinet 10. The lock is a well known device and thus its detailed description is omitted herein for the sake of brevity. The latch assembly comprises the following components as discussed in detail below.

Upper and lower sub-assemblies 20A, 20B each comprise a hollow cylinder 21 having an elongated opening 211 facing outward, a spring 22 anchored on the bottom of the cylinder 21, a rotatable, sliding bolt 23 having one end secured to one end of the spring 22 distal the bottom of the cylinder 21 and the other end projecting out of one end opening of the cylinder 21 in an open position of the cabinet 10, a knob 24 integrally formed with one end of the bolt 23 and projecting out of the opening 211, and a flat plate member 25 integrally formed with the cylinder 21. The upper and lower sub-assemblies 20A, 20B are oriented in opposite directions.

Upper and lower mounting plates 60A, 60B each comprise an offset member 61 to dispose two sections thereof on two parallel surfaces. Thus, a plurality of first screws (not numbered) can be driven through one section of the upper mounting plate 60A (or lower mounting plate 60B) into the door panel 11 to fasten the upper mounting plate 60A (or lower mounting plate 60B) and the door panel 11 together. Further, a plurality of second screws (not numbered) can be driven through the plate member 25 into the other section of the upper mounting plate 60A (or lower mounting plate 60B) to fasten the upper sub-assembly 20A and the upper mounting plate 60A together or the lower sub-assembly 20B and the lower mounting plate 60B together.

Elongated upper and lower driven members 30A, 30B each have an L-section when viewing from top. The upper and lower driven member 30A, 30B each comprise an L-shaped groove 31 proximate one end with the knob 24 slidably projecting out of the groove 31, an elongated slot 32 proximate the other end, a trigger 33 projecting outward at the other end of the upper driven member 30A (or the lower driven member 30B), and a longitudinal section 34. The upper and lower driven members 30A, 30B are oriented in opposite directions. Preferably, the knob 24 is disposed in the lateral section of the corresponding L-shaped groove 31 in an open position of the cabinet 10.

An intermediate interconnecting member 40 comprises an offset member 42 to dispose two sections thereof on two parallel surfaces. The outer surface of the offset member 42 is served as a guide so that the longitudinal section 34 can be smoothly, slidably engaged with the outer surface of the offset member 42. Also, the outer surface of the offset member 61 is served as another guide so that the longitudinal section 34 can be smoothly, slidably engaged with the outer surface of the offset member 61. Thus, a plurality of third screws (not numbered) can be driven through one section of the interconnecting member 40 into the door panel 11 to fasten the interconnecting member 40 and the door panel 11 together. The interconnecting member 40 further comprises two fastening members 41 each driven through the slot 32 into the other section of the interconnecting member 40 to slidably secure either the upper driven member 30A (or the lower driven member 30B) to the interconnecting member 40.

Elongated upper and lower catches 50A, 50B are mounted on an intermediate portion of an inner surface of a top 12 of the cabinet 10 and an intermediate portion of a bottom 13 of the cabinet 10 respectively. Both the upper and lower catches 50A, 50B are disposed proximate to a front opening of the cabinet 10. Each of the upper and lower catches 50A, 50B is shaped as a groove and comprises an inclined member 51 facing inside of the cabinet 10.

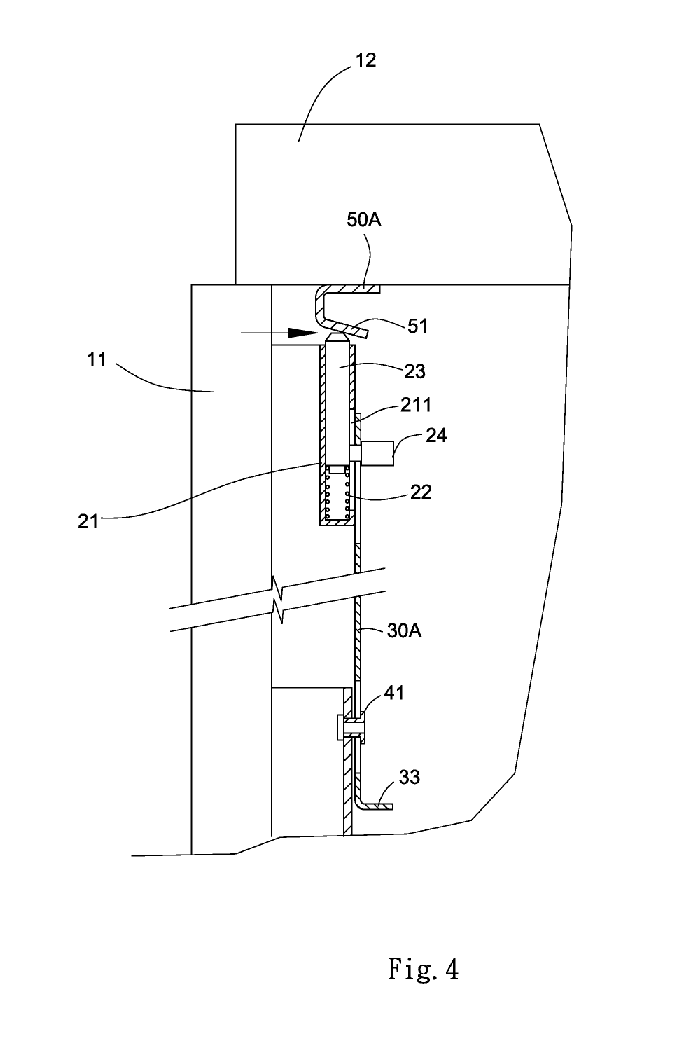

As shown in FIG. 4, for closing the cabinet 10 a person may first pivot each bolt 23 to dispose in the longitudinal section of each L-shaped groove 31. Next, the person may use one hand to pivot the door panel 11 toward the opening of the cabinet 10. The exposed end of each bolt 23 may slide along the corresponding inclined member 51 as indicated by arrow to retract the bolt 23 into the cylinder 21 after contacting the inclined member 51. And in turn, each spring 22 is compressed and each knob 24 moves downward along the corresponding opening 211.

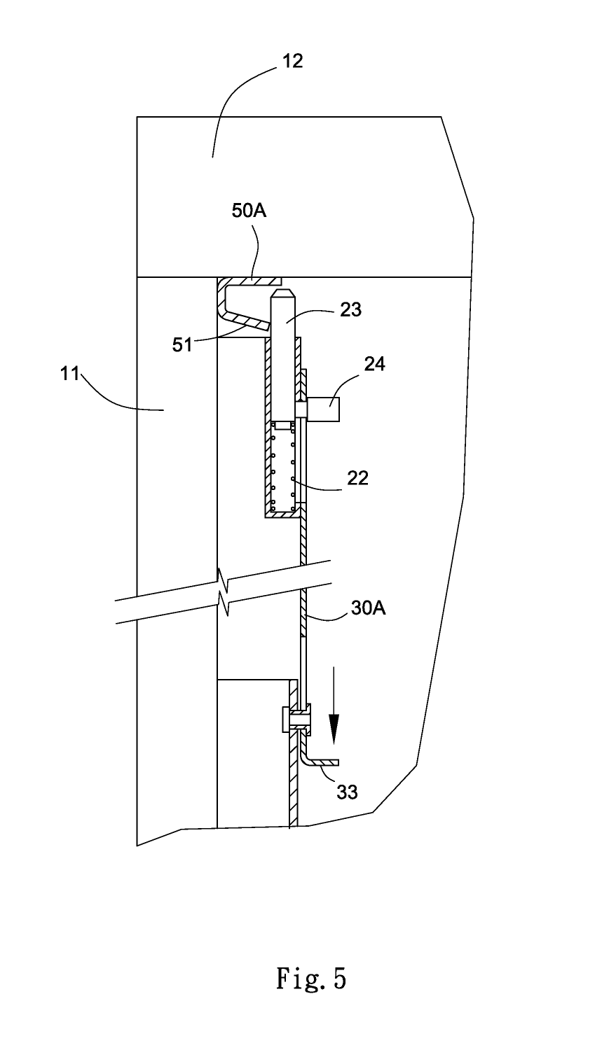

As shown in upper portion of FIG. 5, the pressing force exerted on each bolt 23 by the corresponding inclined member 51 suddenly disappears when the bolt 23 passes the corresponding inclined member 51, i.e., at the end of the pivoting. The stored elastic energy of the springs 22 suddenly push the bolts 23 out of the open ends of the cylinders 21 to dispose at the openings of the catches 50A, 50B. Thus, the door panel 11 (i.e., one door panel 11) is locked. A closing and locking operation of the other door panel can close the cabinet 10.

For opening the door panel 11, a person may use one finger of one hand to push down the trigger 33 of the upper driven member 30A (i.e., the upper driven member 30A) as indicated by arrow in FIG. 5 and another finger of one hand to push up the trigger 33 of the lower driven member 30B (i.e., the lower driven member 30B) at the same time. And in turn, for the upper sub-assembly 20A both the knob 24 and the bolt 23 are lowered with the spring 22 being compressed and for the lower sub-assembly 20B both the knob 24 and the bolt 23 are lifted with the spring 22 being compressed.

For the upper portion of the door panel 11, the pushing down operation can be stopped when the bolt 23 sufficiently retracts into the cylinder 21 and the open end of the bolt 23 clears the inward opening of the upper catch 50A. Similarly, for the lower portion of the door panel 11, the pushing up operation can be stopped when the bolt 23 sufficiently retracts into the cylinder 21 and the open end of the bolt 23 clears the inward opening of the lower catch 50B. As such, the door panel 11 is unlocked. Thereafter, the person may pivot the door panel 11 outward to open the door panel 11.

It is envisaged by the invention that either opening or closing of the door panel 11 can be made by one hand at a time. Thus, it is very convenient and easy.

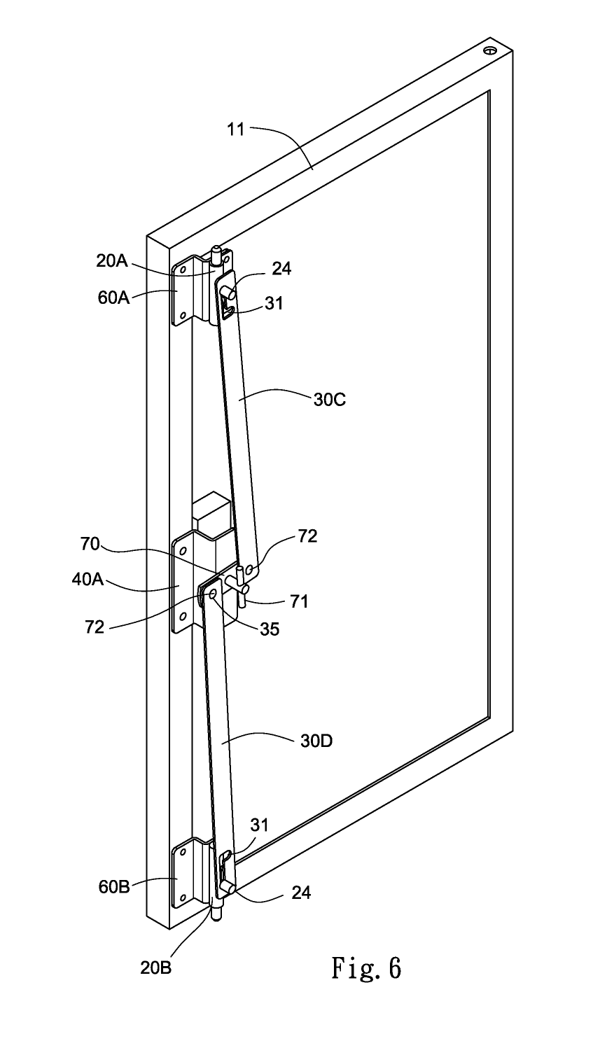

Referring to FIG. 6 in conjunction with FIGS. 1-5, a second latch assembly in accordance with a second preferred embodiment of the invention is shown. The characteristics of the second preferred embodiment are substantially the same as that of the first preferred embodiment as detailed below.

Upper and lower mounting plates 60A, 60B are secured to the door panel 11. The upper and lower sub-assemblies 20A, 20B are secured to the upper and lower mounting plates 60A, 60B respectively. The upper and lower driven plates 30C, 30D are slidably secured to the upper and lower sub-assemblies 20A, 20B respectively.

The elongated, rectangular upper and lower driven plates 30C, 30D each comprise an L-shaped groove 31 proximate one end with the knob 24 slidably projecting out of the groove 31, and a through hole 35 proximate the other end. The upper and lower driven plates 30C, 30D are oriented in opposite directions. For the upper sub-assembly 20A, the knob 24 is urged against one end of the longitudinal section of the L-shaped groove 31 of the upper driven member 30C in a closed position of the cabinet 10. For the lower sub-assembly 20B, the knob 24 is urged against one end of the longitudinal section of the L-shaped groove 31 of the lower driven member 30D in a closed position of the cabinet 10.

An intermediate interconnecting member 40A comprises an offset member (not numbered) to dispose two sections thereof on two parallel surfaces. A rectangular, plate-shaped joining member 70 comprises a T-shaped handle 71 distal the interconnecting member 40A, and two pivot pins 72 at both ends respectively. The handle 71 has one end pivotably secured to the interconnecting member 40A (i.e., the interconnecting member 40A and the joining member 70 pivotably secured together). The pivot pins 72 are pivotably fastened in the through holes 35. That is, either end of the joining member 70 is pivotably secured to the other end of the upper driven plate 30C or the lower driven plate 30D.

For opening one door panel 11, a person may unlock the other door panel and open same. Next, the person may use two fingers of one hand to clockwise turn the handle 71 to push down the upper knob 24 of the upper sub-assembly 20A and lift the lower knob 24 of the lower sub-assembly 20B respectively. The turning will be stopped when the bolts of the upper and lower sub-assemblies 20A, 20B are not locked by the upper and lower catches respectively. Finally, the door panel 11 can be pivoted outwardly to open the cabinet 10.

While the invention has been described in terms of preferred embodiments, those skilled in the art will recognize that the invention can be practiced with modifications within the spirit and scope of the appended claims.

What is claimed is:

1. A latch for releasably locking of one of two hinged door panels of a cabinet comprising:
upper and lower sub-assemblies disposed on upper and lower portions of one side of an inner surface of one door panel respectively, each of the upper and lower sub-assemblies comprising a hollow cylinder having an elongated opening, a biasing member anchored on a bottom of the cylinder, a rotatable, sliding bolt having one end secured to one end of the biasing member distal the bottom of the cylinder and the other end projecting out of the cylinder, and a knob secured to one end of the bolt and projecting out of the elongated opening wherein the upper and lower sub-assemblies are oriented in opposite directions;
upper and lower mounting plates secured to the one door panel wherein the upper mounting plate is secured to the upper sub-assembly and the lower mounting plate is secured to the lower sub-assembly respectively;
upper and lower driven members each comprising a groove at one end with the knob slidably projecting out of the groove, a slot at the other end, and a trigger at the other end of the driven member wherein the upper and lower driven members are oriented in opposite directions;
an intermediate interconnecting member secured to the one door panel and comprising two fastening members each driven through the slot into the interconnecting member to slidably secure each of the driven members to the interconnecting member; and
upper and lower catches mounted on an intermediate portion of an inner surface of a top of the cabinet and an intermediate portion of a bottom of the cabinet respectively, the upper and lower catches lock the bolts of the upper and lower sub-assemblies respectively in a closed position of the one door panel.

2. The latch of claim 1, wherein the upper and lower sub-assemblies each comprise a flat plate member integrally formed with the cylinder, and wherein the plate member of the upper sub-assembly is secured to the upper mounting plate and the plate member of the lower sub-assembly is secured to the lower mounting plate respectively.

3. The latch of claim 2, wherein the interconnecting member comprises an offset member to dispose two sections thereof on two parallel surfaces; wherein the driven members each have a cross-section of L and further comprise a longitudinal section slidably engaged with the offset member.

4. The latch of claim 3, wherein the upper and lower mounting plates each comprise an offset member, and wherein the offset member of the upper mounting plate is slidably engaged with the longitudinal section of the upper driven member and the offset member of the lower mounting plate is slidably engaged with the longitudinal section of the lower driven member respectively.

5. The latch of claim 1, wherein the groove is shaped as an L.

6. A latch for releasably locking of one of two hinged door panels of a cabinet comprising:
upper and lower sub-assemblies disposed on upper and lower portions of one side of an inner surface of one door panel respectively, each of the upper and lower sub-assemblies comprising a hollow cylinder having an elongated opening, a biasing member anchored on a bottom of the cylinder, a rotatable, sliding bolt having one end secured to one end of the biasing member distal the bottom of the cylinder and the other end projecting out of the cylinder, and a knob secured to one end of the bolt and projecting out of the elongated opening wherein the upper and lower sub-assemblies are oriented in opposite directions;
upper and lower mounting plates secured to the one door panel wherein the upper mounting plate is secured to the upper sub-assembly and the lower mounting plate is secured to the lower sub-assembly respectively;
upper and lower driven members each comprising an L-shaped groove at one end with the knob slidably projecting out of the groove wherein the upper and lower driven members are oriented in opposite directions;
an intermediate interconnecting member secured to the one door panel;
a joining member having both ends pivotably secured to the other end of the upper driven member and the other end of the lower driven member respectively, the joining member comprising a handle pivotably secured to the interconnecting member so that a rotation of the handle pivots the joining member about each of the upper and lower driven members and moves the bolts further into the cylinders with the biasing members being compressed; and
upper and lower catches mounted on an intermediate portion of an inner surface of a top of the cabinet and an intermediate portion of a bottom of the cabinet respectively, the upper and lower catches lock the bolts of the upper and lower sub-assemblies respectively in a closed position of the one door panel.

7. The latch of claim 6, wherein the handle is shaped as a T.
